(19) United States
(12) Patent Application Publication
(10) Pub. No.: US 2024/0258772 A1
(43) Pub. Date: Aug. 1, 2024

(54) SPARK PLUG CONNECTOR

(71) Applicant: INNIO Jenbacher GmbH & Co OG, Jenbach (AT)

(72) Inventors: Markus Kraus, Wiesing (AT); Matthias Zippel, Spangenberg (DE); Nico Meintker, Taufkirchen (DE)

(21) Appl. No.: 18/424,675

(22) Filed: Jan. 26, 2024

(30) Foreign Application Priority Data
Jan. 27, 2023 (DE) DE102023102071.4

(51) Int. Cl. H01T 13/05

(52) U.S. Cl. CPC H01T 13/05

(57) ABSTRACT

Spark plug connector with a connector body, which has a first end portion for inserting an end of a high-tension lead and a second end portion for receiving an end of a spark plug, wherein an electrical wiring section for transmitting a sparking voltage from the high-tension lead to the spark plug is arranged between the first end portion and the second end portion, and wherein the electrical wiring section has, adjacent to the first end portion, at least one inductor; internal combustion engine with at least one arrangement consisting of a spark plug and such a spark plug connector; and arrangement with a device to be driven mechanically and at least one such internal combustion engine for driving the device to be driven mechanically.

### CROSS-REFERENCE TO RELATED APPLICATION

This application claims priority to and benefit of German Application No. DE102023102071.4, filed on Jan. 27, 2023, entitled “SPARK PLUG CONNECTOR”, which is herein incorporated by reference in its entirety.

### BACKGROUND

The invention relates to a spark plug connector with the features of the claims, an internal combustion engine with at least one arrangement consisting of a spark plug and such a spark plug connector, and an arrangement with a device to be driven mechanically and at least one such internal combustion engine.

It is known that the ignitions in an internal combustion engine result in electromagnetic interference emissions, which can be reduced only with difficulty and marginally using conventional interference suppression measures.

In connection with the ignition sparks in internal combustion engines, substantial electromagnetic interference emissions can occur during the formation and maintenance of the spark or of partial discharges.

### BRIEF DESCRIPTION

An aspect of the invention is to provide a spark plug connector, an internal combustion engine with at least one arrangement consisting of a spark plug and such a spark plug connector, and an arrangement with a device to be driven mechanically and at least one such internal combustion engine, in which electromagnetic interference emission due to the ignition is reduced.

This aspect is achieved by a spark plug connector with the features of the claims, an internal combustion engine with at least one arrangement consisting of a spark plug and such a spark plug connector, and by an arrangement consisting of a device to be driven mechanically and at least one such internal combustion engine, in particular a genset with a generator for electricity generation.

Such a spark plug connector has a connector body (formed approximately cylindrical), with a first end portion for inserting an end of a high-tension lead or for directly contacting an ignition coil and a second end portion for receiving an end of a spark plug. An electrical wiring section for transmitting a sparking voltage from the high-tension lead or the ignition coil to the spark plug is arranged between the first end portion and the second end portion. The electrical wiring section has at least one inductor—preferably directly—adjacent to the first end portion, with the result that the at least one inductor lies in the region of the end of a spark plug well or in the region of a valve cover (preferably covering approximately 50%, wherein 100% position in the spark plug well or over the spark plug well is also possible, but preferably with at most approximately 20 mm above and/or below the end of the spark plug well—alternatively the upper side of the valve cover).

The electromagnetic interference emission due to the ignition can be significantly reduced by arranging at least one inductor in the electrical wiring section adjacent to the first end portion. The at least one inductor can also be called an electromagnetic interference suppression element.

Such an internal combustion engine has at least one arrangement consisting of a spark plug and such a spark plug connector, wherein the arrangement is held on or in a valve cover or a spark plug well of an internal combustion engine.

Such an arrangement, in particular a genset, has at least one such internal combustion engine for driving the device to be driven mechanically, in particular a generator for electricity generation. A further example of a device to be driven mechanically is a pump.

Advantageous embodiments of the invention are defined in the dependent claims.

The high-tension lead can be implemented for example as a flexible high-tension cable or as a rigid electrically conductive element.

In one embodiment, it is provided that the electrical wiring section has, adjacent to the first end portion, at least two, preferably three, inductors, which are arranged directly against each other or at a distance from each other in the direction of the second end portion. This has surprisingly proved to be extremely advantageous with respect to the reduction of the electromagnetic interference emission.

In one embodiment, it is provided that the electrical wiring section has, adjacent to the at least one inductor in the direction of the second end portion, an interconnection, for example an electrically conductive mechanical spring or an electrically conductive rod, for contacting the spark plug.

In one embodiment, it is provided that at least one inductor of the at least one inductor is formed in the form of a coil, preferably without a core of magnetic material, such as ferrite or iron. Without a magnetizable core, there is no change over the frequency response.

In one embodiment, it is provided that the at least one inductor has in total a value of at least 5 mH, preferably of at least 10 mH.

In one embodiment, it is provided that the at least one inductor extends over a range of from approximately 30 mm to approximately 100 mm, preferably approximately 50 mm.

In one embodiment, it is provided that the electrical wiring section has at least one ohmic resistor (for example, between 1 kΩ and 3 kΩ) as an additional interference suppression element.

In one embodiment, it is provided that the spark plug connector is formed without a screening shield. Screening shields, which are located over the spark plug as a component of the spark plug connector, are known in the state of the art.

In one embodiment, it is provided that a plate for holding on a valve cover of an internal combustion engine is arranged on the connector body. The plate can, for example, be made of metal or an electrically non-conductive material. Alternatively, a fastening of the spark plug connector can be effected via the spark plug and/or the spark plug well.

In one embodiment, it is provided that an ignition coil is arranged spaced apart from the valve cover and is connected to the electrical wiring section of the spark plug connector via the high-tension lead.

In an alternative embodiment, it is provided that an ignition coil is arranged directly on the first end portion of the connector body of the spark plug connector.

In one embodiment, it is provided that the at least one arrangement is arranged in the valve cover via a preferably multi-part spark plug sleeve. Naturally, a single-part formation of the spark plug sleeve would also be possible.

If a spark plug sleeve is provided, it can be arranged concentric or eccentric to the spark plug connector.

The internal combustion engine is preferably formed stationary.

The internal combustion engine preferably has more than six arrangements consisting of an embodiment of a spark plug connector and a spark plug and/or more than one and a half liters, preferably more than two liters, of engine displacement, per combustion chamber. Each arrangement serves to ignite a fuel gas or fuel gas/air mixture introduced into a combustion chamber of the internal combustion engine.

### BRIEF DESCRIPTION OF THE DRAWINGS

Embodiments of the invention are discussed with reference to the figures.

FIG. 1 shows, in a sectional representation through a central plane of a spark plug connector, a detail of an internal combustion engine with an arrangement consisting of a first embodiment of a spark plug connector and a spark plug.

FIG. 2A shows, in a sectional representation through a central plane of a spark plug connector, a detail of an internal combustion engine with an arrangement consisting of a second embodiment of a spark plug connector and an ignition coil.

FIG. 2B shows, in a sectional representation through a central plane of a spark plug connector, a detail of an internal combustion engine with an arrangement consisting of a third embodiment example of a spark plug connector and an ignition coil.

FIG. 3A shows, in a sectional representation through a central plane of a spark plug connector, a detail of an internal combustion engine with an arrangement consisting of a fourth embodiment of a spark plug connector and a spark plug.

FIG. 3B shows, in a sectional representation through a central plane of a spark plug connector, a detail of an internal combustion engine with an arrangement consisting of a fifth embodiment of a spark plug connector and a spark plug.

FIG. 3C shows, in a sectional representation through a central plane of a spark plug connector, a detail of an internal combustion engine with an arrangement consisting of a sixth embodiment of a spark plug connector and a spark plug.

FIG. 3D shows a detail of an internal combustion engine with an arrangement consisting of a seventh embodiment of a spark plug connector and a spark plug.

FIG. 4A shows, in a sectional representation through a central plane of a spark plug connector, an embodiment of a possibility of fastening a spark plug connector to a valve cover.

FIG. 4B shows, in a sectional representation through a central plane of a spark plug connector, an embodiment of a possibility of fastening a spark plug connector to a spark plug.

FIG. 5 shows a schematic representation of an embodiment of an arrangement with an internal combustion engine and a device to be driven mechanically.

FIG. 6 shows the effect of embodiments of the invention.

### DETAILED DESCRIPTION

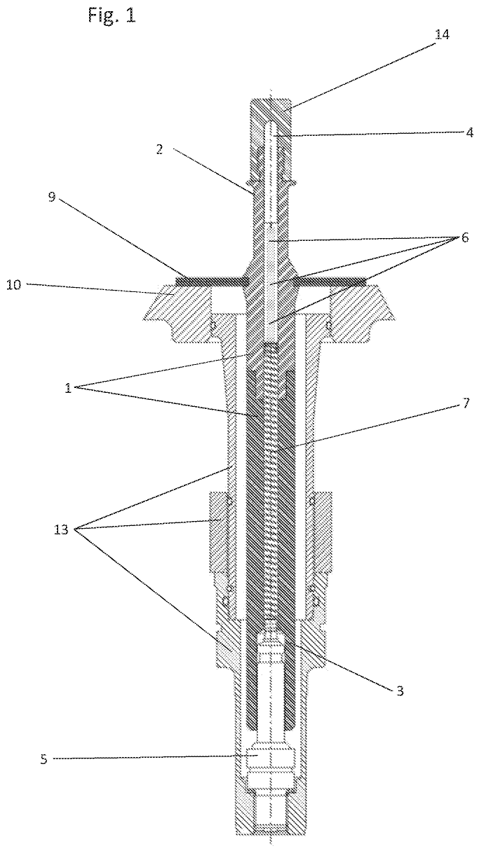

An arrangement consisting of a first embodiment of a spark plug connector and a spark plug 5 is shown in FIG. 1. This arrangement is arranged in a valve cover 10 of an internal combustion engine 11 via a spark plug sleeve 13, formed multi-part here, and is held on the valve cover 10 via a plate 9.

From an ignition coil, not represented in the figures, a sparking voltage is conducted via a high-tension lead 4, which is implemented here as a high-tension cable and which (guided via a cable guide 14 formed, for example, as a rubber grommet) enters the connector body 1 at a first end portion 2 thereof, to the spark plug connector and is guided, via an electrical wiring section which runs inside the connector body 1 of the spark plug connector, to a spark plug 5, which is arranged partially in a second end portion 3 of the connector body 1. Contrary to what is represented, the connector body 1 can also be formed as a single-part.

The electrical wiring section in this embodiment (in a sequence starting from the first end portion 2 towards the second end portion 3) consists of three inductors 6 and an interconnection 7.

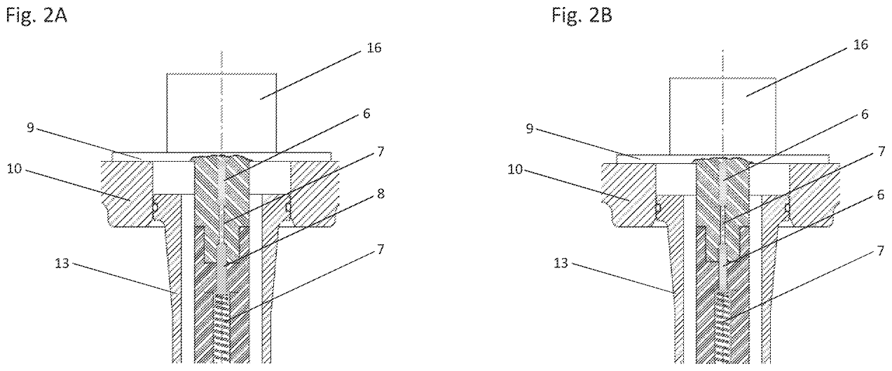

In FIG. 2A, a detail of an internal combustion engine 11 with an arrangement consisting of a second embodiment of a spark plug connector and a spark plug 5 is represented, wherein the electrical wiring section here (in a sequence starting from the first end portion 2 towards the second end portion 3) consists of an inductor 6, an interconnection 7, an ohmic resistor 8, and a further interconnection 7. In this embodiment, an ignition coil 16 is arranged directly on the first end portion 2 of the connector body 1. Contrary to what is represented, the ignition coil 16 need not be arranged concentric to the axis of the spark plug well.

In FIG. 2B, a detail of an internal combustion engine 11 with an arrangement consisting of a third embodiment of a spark plug connector and a spark plug 5 is represented, wherein the electrical wiring section here (in a sequence starting from the first end portion 2 towards the second end portion 3) consists of a first inductor 6, an interconnection 7, a second inductor 6, and a further interconnection 7. In this embodiment, an ignition coil 16 is arranged directly on the first end portion 2 of the connector body 1.

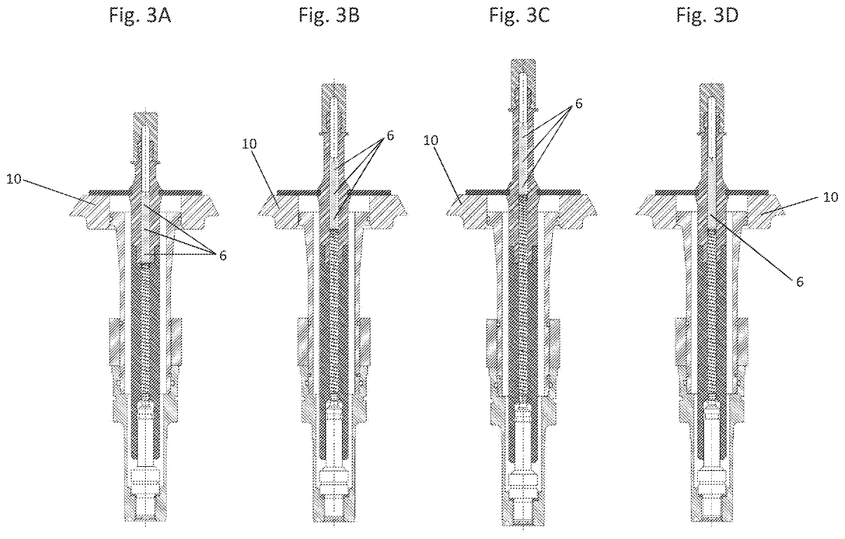

FIGS. 3A to 3D show different possibilities of placing the at least one inductor 6 relative to the valve cover 10, namely underneath the valve cover 10 (FIG. 3A), partially on top of and partially underneath the valve cover 10 (FIGS. 3B and 3D) and on top of the valve cover 10 (FIG. 3C).

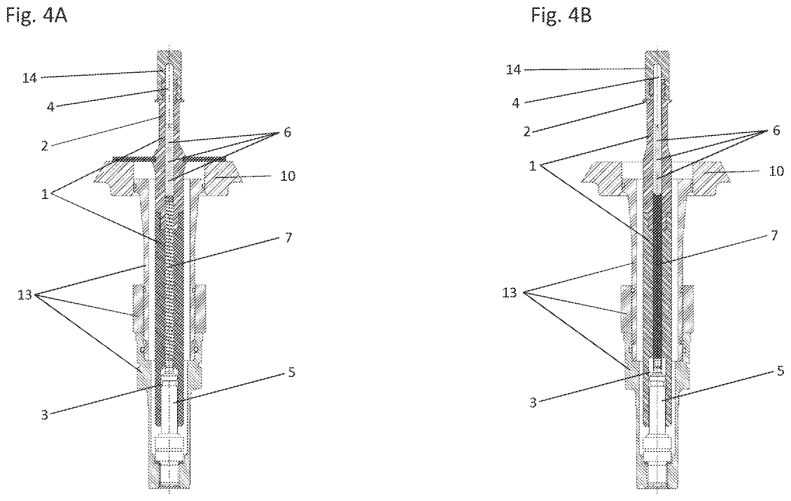

FIG. 4A shows the possibility of fastening an arrangement consisting of a spark plug connector, a spark plug 5, and a spark plug sleeve 13 to an upper side of the valve cover 10 via a plate 9.

FIG. 4B shows the possibility of fastening an arrangement consisting of a spark plug connector, a spark plug 5, and a spark plug sleeve 13 over the spark plug 5 in the region of an underside of the valve cover 10, which delimits a combustion chamber, not represented, of the internal combustion engine 11.

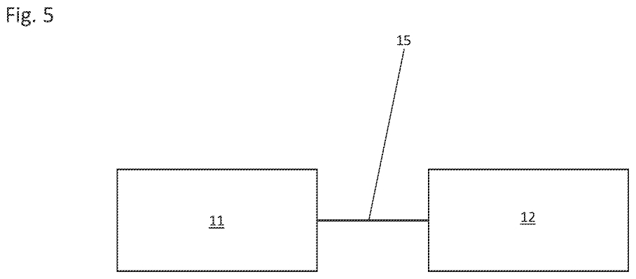

In FIG. 5, an arrangement with a device 12 to be driven mechanically, for example, a genset with a generator 12 for electricity generation, and an internal combustion engine 11 which is connected thereto via a mechanical axle 15 in order to drive the device 12 is schematically represented. The internal combustion engine 11 is formed stationary and has more than six arrangements consisting of an embodiment of a spark plug connector and a spark plug 5.

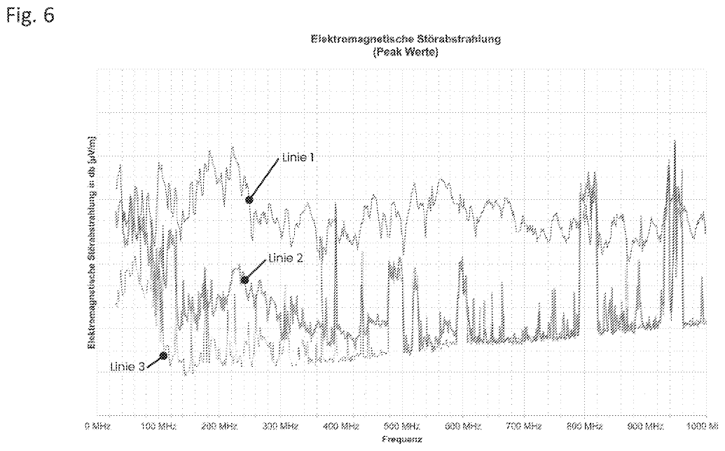

FIG. 6 shows the effect of embodiments of the invention, namely, a significant reduction of the electromagnetic interference emission during the ignition of a spark plug (logarithmic representation).

Line 1 shows the interference emission with conventional interference suppression measures.

Line 2 shows the interference emission when one of the embodiments of a spark plug connector from the present disclosure is used. A lowering of the envelope of line 2 compared with the envelope of line 1 of from approximately 10 up to 30 db mV/m is recognized.

Line 3 shows the basic interference level without ignition, for comparison.

### REFERENCE NUMBERS

1 connector body
2 first end portion of the connector body
3 second end portion of the connector body
4 high-tension lead
5 spark plug
6 inductor
7 interconnection
8 ohmic resistor
9 plate
10 valve cover of an internal combustion engine
11 internal combustion engine
12 device to be driven mechanically, in particular generator
13 spark plug sleeve
14 cable guide for high-tension lead
15 axle
16 ignition coil

1. A system, comprising:
a spark plug connector comprising a connector body having a first end portion configured to insert an end of a high-tension lead or to directly contact an ignition coil and a second end portion configured to receive an end of a spark plug, wherein an electrical wiring section configured to transmit a sparking voltage from the high-tension lead or the ignition coil to the spark plug is arranged between the first end portion and the second end portion, wherein the electrical wiring section has, adjacent to the first end portion, at least one inductor as an electromagnetic interference suppression element.

2. The system of claim 1, wherein the electrical wiring section is directly adjacent to the first end portion.

3. The system of claim 1, wherein the electrical wiring section has, adjacent to the first end portion, at least two inductors arranged directly against each other or at a distance from each other in the direction of the second end portion.

4. The system of claim 1, wherein the electrical wiring section has, adjacent to the at least one inductor in a direction of the second end portion, an interconnection configured to contact the spark plug.

5. The system of claim 1, wherein one or more of the at least one inductor comprises a coil without a core of magnetic material.

6. The system of claim 1, wherein the at least one inductor has in total a value of more than 5 mH.

7. The system of claim 1, wherein the at least one inductor extends in total over a range of from approximately 30 mm to approximately 100 mm.

8. The system of claim 1, wherein the electrical wiring section has at least one ohmic resistor as an additional interference suppression element.

9. The system of claim 1, wherein the spark plug connector is formed without a screening shield.

10. The system of claim 1, wherein a plate is arranged on the connector body, and the plate is configured to hold on a valve cover of an internal combustion engine.

11. The system of claim 1, wherein the connector body is formed multi-part.

12. The system of claim 1, comprising an internal combustion engine with at least one arrangement comprising the spark plug and the spark plug connector, wherein the arrangement is held on or in a valve cover of the internal combustion engine or a spark plug well, wherein the end of the high-tension lead is inserted into the first end portion of the connector body and is electrically connected to the electrical wiring section.

13. The system of claim 12, wherein the ignition coil is arranged spaced apart from the valve cover and is connected to the electrical wiring section of the spark plug connector via the high-tension lead.

14. The system of claim 12, wherein the at least one arrangement is arranged in the valve cover via a multi-part spark plug sleeve.

15. The system of claim 12, wherein the internal combustion engine has more than six arrangements of the at least one arrangement and/or more than one and a half liters of engine displacement per combustion chamber and/or the internal combustion engine is formed as a stationary internal combustion engine.

16. The system of claim 12, wherein the at least one inductor lies in a region of an end of a spark plug well or in a region of the valve cover, covering approximately 50% to 100% in the spark plug well or over the spark plug well, with at most approximately 20 mm above and/or below the end of the spark plug well or alternatively an upper side of the valve cover.

17. The system of claim 12, comprising a device to be driven mechanically by the internal combustion engine, wherein the devices comprise an electrical generator or a pump.

18. A method, comprising:
suppressing electromagnetic interference associated with ignition of an internal combustion engine at least with one or more inductors along a spark plug connector configured to extend between and connect a spark plug with a conductive lead.

19. The method of claim 18, wherein one or more inductors are disposed adjacent to a first end portion of the spark plug connector coupled to the conductive lead.

20. A system, comprising:
a spark plug connector configured to extend between and connect a spark plug with a conductive lead, wherein the spark plug connector comprises one or more inductors configured to suppress electromagnetic interference associated with ignition of an internal combustion engine.
